(19) United States
(12) Patent Application Publication
(10) Pub. No.: US 2005/0061322 A1
(43) Pub. Date: Mar. 24, 2005

(54) Method and arrangement for reducing the volume of a lung

(75) Inventor: Lutz Freitag, Hemer (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: PULMONx, Palo Alt, CA (US)

(21) Appl. No.: 10/981,346

(22) Filed: Nov. 3, 2004

(30) Foreign Application Priority Data
Jan. 20, 2003 (DE) DE10302310.0

(51) Int. Cl. A62B 7/00

(52) U.S. Cl. 128/204.18

(57) ABSTRACT

The invention relates to a method and an arrangement for reducing the volume of a patient's lung. A bronchial catheter (2) is introduced into a hyperexpanded lung area, and air is aspirated from there by means of an aspiration device (3). The associated segmental bronchus is then closed. According to the invention, the patient's spontaneous respiration is recorded by sensors (5), and aspiration of the air is carried out in synchrony with the patient's inhalation action. In order to prevent collapse of the associated segmental bronchus, a pressure generator is provided with which the associated segmental bronchus can be widened, by a compressed gas pulse, in synchrony with the aspiration. The pressure generator can be activated as a function of the aspirated air stream, which is monitored with a measuring device.

### CROSS-REFERENCES TO RELATED APPLICATIONS

This application is a continuation-in-part of PCT/DE2004/000008 (Attorney Docket No. 017354-002700PC), filed on Jan. 7, 2004, which claimed priority from DE10302310.0, filed on Jan. 20, 2003, the full disclosures of which are incorporated herein by reference.

### BACKGROUND OF THE INVENTION

Field of the Invention

The invention relates to a method and an arrangement for reducing the volume of a lung in a patient suffering from pulmonary emphysema.

Pulmonary emphysema is, in general terms, a hyperexpansion of the lung tissue. It develops when pulmonary alveoli and terminal bronchioles burst and are destroyed, so that, instead of a large number of small pulmonary alveoli, a small number of large air cells, or regular sacs, develop. This leads to a reduction in the surface area for gas exchange. This means that the capacity for intake of oxygen and release of carbon dioxide is then much lower. Even very slight physical exertion then causes breathlessness.

The loss of the alveolar structure changes the elasticity and compliance of the organ of respiration. These features, however, are prerequisites for undisturbed breathing. The lung, which expands greatly upon deep inhalation, draws back in again completely by itself as the tension in the muscle is released, by virtue of its elasticity. This no longer happens in the case of emphysema, or at least no longer to a sufficient extent. After inhalation, the lung remains large and filled with air. Exhalation is impeded or even prevented. The respiratory air inhaled remains for the most part in the thoracic cage, and no new, fresh air can be inhaled. In extreme cases, the subject affected is in a permanent state of inhalation. This can be compensated at rest. However, even the slightest exertion causes shortness of breath, and soon a regular pattern of dyspnoea, the typical symptom of pulmonary emphysema.

U.S. Pat. No. 6,287,290 B1 discloses a method and a device in which a hyperexpanded lung area is reduced in volume via a bronchial catheter by means of an aspiration device. A plug or a stent is then inserted into the associated segmental bronchus. This method starts from the premise that, in the case of massive hyperexpansion in part of the thoracic cage, relief is obtained when the affected part of the lung is shut down. Although the lung is then smaller of course, it gains greater freedom of movement.

In practice, however, it may be difficult to aspirate air from the emphysematous area. The reason may be that it is not just the lung tissue itself that is affected by emphysema, but also the associated airways. The associated airways may become weaker as the disease progresses and they lose their resiliency. Thus, aspiration can cause collapse of the associated segmental bronchus. Such collapse of the segmental bronchus can make the aspiration procedure more difficult and in some cases might prevent it completely.

It is therefore desirable to provide improved methods for volume reduction of the lung to permit effective aspiration of a hyperexpanded lung area and to provide systems suitable for this purpose. At least some of these objectives will be met by the present invention.

### BRIEF SUMMARY OF THE INVENTION

Methods and apparatus according to the present invention inhibit collapse of the segmental bronchus or lung tissue during aspiration associated with lung volume reduction procedures. More specifically, the methods and apparatus of the present invention provide for aspiration synchronous with the patient's respiration cycle to remove air during periods of patient inhalation when the bronchus or airways leading to or within the hyperextended lung region being treated are generally open and available to transport air from the region. Conversely, aspiration is not performed during patient exhalation when the airways leading to and/or within the hyperextended lung region may be subject to collapse which would prevent or inhibit air transport from the region. Alternatively or additionally, airway collapse can be inhibited or reversed by short pulses of pressurized gas.

A bronchial catheter is introduced into a hyperexpanded lung area, and air is aspirated from there by means of an aspiration device. During treatment, the patient's spontaneous respiration is recorded. This can be done manually, but preferably is accomplished automatically using sensors and measuring devices. Aspiration of the air from the emphysematous or otherwise hyperextended lung region is carried out in synchrony with the patient's inhalation action. The invention thus makes use of the characteristic that that the lung is expanded during inhalation. The lung draws the bronchi away from one another. This phenomenon is known as interdependence. According to the invention, it is in this expanded state during inspiration or inhalation that aspiration of the isolated region to be treated is carried out. In this way, the risk of collapse of the surrounding airways upon application of an underpressure can be lessened.

In an alternative aspect of the present invention, the bronchus leading to or within the isolated region to be aspirated may be widened by a compressed gas pulse during aspiration of the air. By pulsing compressed gas, the airways adjacent to the distal end of the bronchial catheter are widened and opened prior to or during the aspiration procedure. Optionally, potential collapse of the bronchus or airways may be visually or otherwise monitored, and a short overpressure pulse expediently delivered whenever a potential collapse is detected. The action of the compressed gas results in short pressure peaks. By this means, the bronchus can be widened exactly at the time of a collapse. This allows the desired aspiration to be carried out.

Various compressed gases can be used, for example, compressed air, heliox, helium, or oxygen. Heliox appears to be especially suitable because this gas has a low viscosity and thus flows very rapidly.

Using the approach proposed in accordance with the invention, a substantially improved aspiration process can be expected in the case of pulmonary emphysema. After the hyperexpanded lung tissue has emptied and has contracted, the corresponding associated segmental bronchus is closed by suitable means. Various implants such as stents or plugs are available for this purpose as described in U.S. Pat. Nos. 6,287,290 and 6,527,761, the full disclosures of which are incorporated herein by reference.

Systems according to the present invention comprise sensors for monitoring the patient's spontaneous respiration which communicate with a control unit for activating the aspiration device. The spontaneous respiration can be monitored in various ways. For example, it is conceivable to measure sound or flow at the patient's mouth or nose or on the bronchial catheter. The thorax impedance or thoracic cage expansion can also be measured electrically and used as a control signal. Finally, the bronchoscopy image can be evaluated in order to determine the state of expansion of the bronchi. Aspiration takes place during expansion (open) of the bronchi during inhalation and ceases during exhalation. Of course, it is not essential that the initiation and termination of aspiration be precisely synchronized with actual respiration, but a close synchronization is preferred.

To provide a pulsed compressed gas, a pressure generator is usually coupled to a valve unit. The arrangement is time-controlled in such a way that a compressed gas pulse can be delivered to the lung or associated segmental bronchus in synchrony with the aspiration of air and/or when a pressure drop is detected.

A particularly advantageous arrangement comprises a measuring device coupled to activate the pressure generator as a function of the aspirated air stream. This can take place when no further flow or air stream is registered or when the aspirated air stream falls below a predetermined limit value. By means of the compressed gas pulse, the associated segmental bronchus is then widened, so that the aspiration procedure can be carried out.

Preferably the aspiration procedure should not be carried out when the affected segmental bronchus collapses, and, in the event of a collapse, the volume should be expanded by means of a compressed gas stream. To determine the actual situation in the body during treatment, an image can also be recorded in situ. An imaging unit may form a component part of the system and be linked to a data processing unit for controlling the pressure generator. The images are continuously monitored, and the image information is then converted to digital signals and, if appropriate after contrast enhancement, used to evaluate the state in the lung area. In this way, a collapse, or an imminent collapse, can be detected, and a suitable compressed gas pulse can be generated in good time.

According to the methods of the present invention, a hyperextended region of a patient's lung may be aspirated by monitoring the patient's respiration to determine periods of inspiration and exhalation. Air is aspirated from the hyperextended region during periods of inspiration but not during periods of exhalation. As noted above, it is not essential that the period of aspiration be in close synchrony with the respiration, but generally the aspiration should occur during normal inspiration or inhalation by the patient and should not occur during normal exhalation by the patient. The phrases “normal inspiration” and “normal exhalation” refer to inhalation and exhalation in the bulk of the patient's lung, excluding the hyperextended region which has been isolated to permit aspiration.

Usually, aspirating airflow from the hyperextended region will comprise isolating the hyperextended region from the other regions of the lung using a bronchial catheter. A negative pressure is applied to the isolated region through the bronchial catheter during the periods of aspiration but generally not during periods of exhalation. Monitoring may comprise any convenient protocol for determining when a patient is naturally inhaling and exhaling. Exemplary methods include the use of a thorax impedance sensor on the patient's chest, the use of an acoustic measurement sensor, and the use of an inductance respirometer.

The methods of the present invention optionally further comprise delivering compressed gas through the bronchial catheter to the hyperextended region prior to and/or during an initial phase of aspiration. As discussed in more detail above, providing a pulse of compressed gas can act to widen the bronchus or airways leading to and/or within the isolated lung region being treated.

Systems according to the present invention for aspirating a hyperextended region of a patient's lung will comprise a bronchial catheter, a sensor, and an aspiration device. The bronchial catheter will usually be configured to access and optionally isolate the hyperextended lung region. The sensor will be configured to distinguish between periods of inspiration and exhalation during the patient's spontaneous respiration cycle, and the aspiration device will be connectable to both the bronchial catheter and the sensor. The aspiration device will usually have a control unit, and the control unit will usually be configured to aspirate air from the hyperextended region during periods of inspiration but not during periods of exhalation. Suitable sensors include thorax impedance sensors, sound sensors, inductance respirometers, and the like. The may further comprise a gas pulse generator connectable to the bronchial catheter and to the sensor. The gas pulse generator will typically have a valve unit which delivers compressed gas through the bronchial catheter to the hyperextended region prior to and/or during an initial phase of aspiration through the aspiration device. The system may further comprise an imaging unit for imaging the hyperextended lung area during treatment. The imaging unit may be used to observe or monitor the hyperextended region to detect the actual or potential collapse of the region. With such a unit, the gas pulse generator can be initiated at any time when potential collapse is observed.

### BRIEF DESCRIPTION OF THE DRAWINGS

FIG. 1 is a diagrammatic representation of an arrangement for reducing the volume of a lung during treatment of a patient.

FIG. 2 is a technically simplified representation of a first embodiment of an arrangement according to the invention.

FIG. 3 is a diagram showing the time profile and match between respiration and aspiration.

FIG. 4 shows a second embodiment of an arrangement according to the invention for reducing the volume of a lung.

FIG. 5 is a diagram showing the time profile of an aspiration procedure.

### DETAILED DESCRIPTION OF THE INVENTION

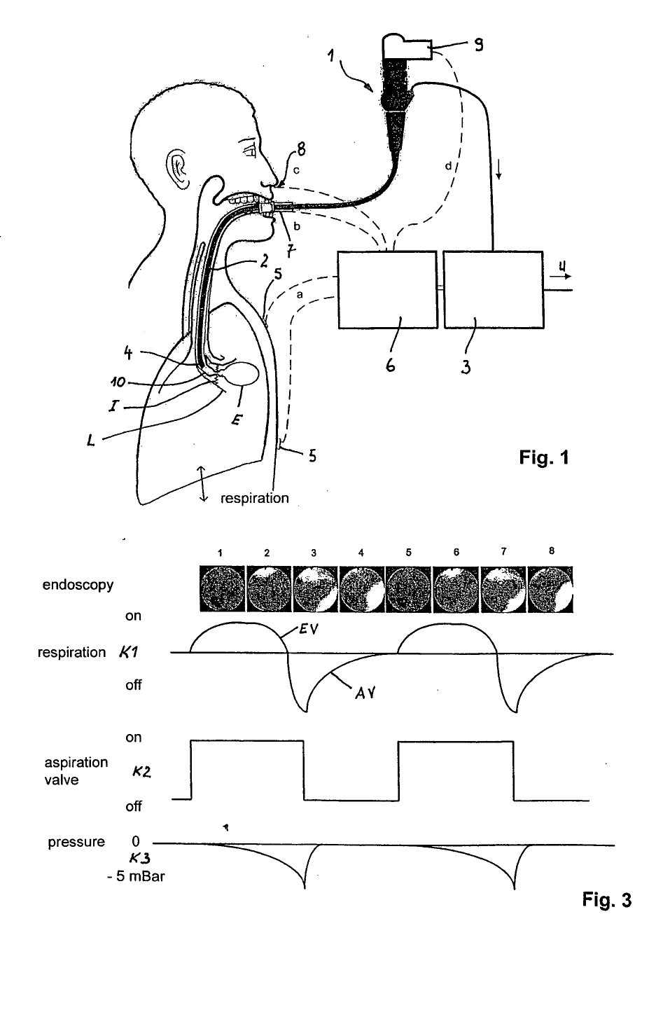

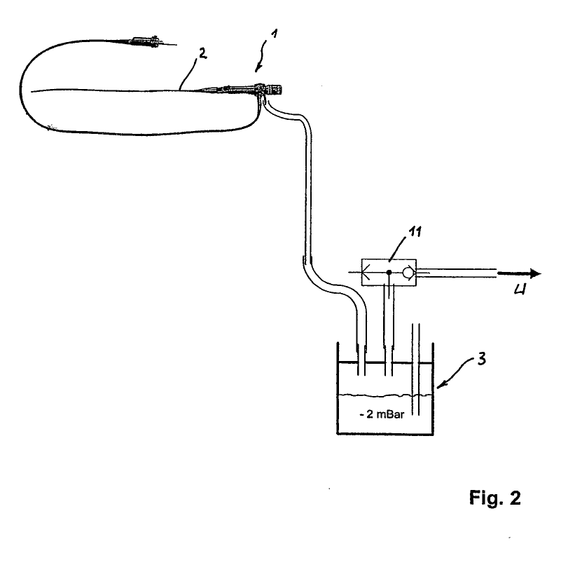

FIG. 1 shows a diagrammatic representation of an arrangement according to the invention for reducing the volume of a lung L of a patient, who suffers from pulmonary emphysema, during treatment. The lung area affected by the emphysema is designated by E. The basic structure of the arrangement can be seen from FIG. 2.

The arrangement comprises a bronchoscope 1 with a bronchial catheter 2 which communicates with an aspiration device 3. The bronchial catheter 2 is introduced into the hyperexpanded lung area. There, the distal end 4 of the bronchial catheter 2 can be sealed off relative to the surrounding vessel wall by means of suitable blockers (not shown here). Sensors 5 secured on the patient's chest record the patient's spontaneous respiration by measuring the thorax impedance. The measurement values recorded by the sensors 5 are evaluated by computer in a control unit 6, forming a component part of the aspiration device, 3 and are used for controlling the aspiration procedure (line a). FIG. 1 also shows that the patient's respiration can also be monitored by an acoustic measurement sensor 7 and/or a sensor 8 placed on the patient's nose, for example by means of inductance respirometry. The sensors 7 and 8 are connected to the control unit 6 (lines b and c). The figure also shows an imaging unit 9 in the form of a video camera on the bronchoscope 1, which unit 9 is also connected to the control unit 6 (line d). The imaging unit 9 can be used to visually record the actual situation in the lung area to be treated.

The lung expands upon inhalation. As this happens, the segmental bronchus 10 leading to the emphysema E is also widened by the interconnected bronchi. This elasticity of the bronchi and their interconnection is indicated diagrammatically in FIG. 1 by the springs I (interdependence). To avoid the segmental bronchus 10 collapsing upon application of an underpressure U, the aspiration of the air is carried out in synchrony with the inhalation action of the patient. This means that whenever the patient inhales and, as a result, the lung L and the associated segmental bronchus 10 are expanded, an aspiration valve 11 (see FIG. 2) of the aspiration device 3 is opened, so that the aspiration of the air from the emphysematous area is carried out in accordance with the inhalation rhythm.

The time profile and the match between respiration and the aspiration procedure is illustrated in the diagram in FIG. 3.

The upper image sequence shows actual images (1-8) of the situation recorded endoscopically in the associated segmental bronchus 10.

The upper curve K1 shows the respiration, the curve portions designated by EV indicating the inhalation action and the curved portions designated by AV indicating the exhalation action. The middle curve K2 shows the control of the aspiration valve 11 with ON/OFF switching states. The lower curve K3 shows the pressure profile during the aspiration procedure.

It will be seen that, in the inhalation action EV, the aspiration valve 11 is open. The segmental bronchus 10 is open in this phase (images 1 and 2 of the endoscopy sequence). As exhalation starts, the segmental bronchus 10 collapses. This process starts in image 3 of the endoscopy sequence. In image 4, the segmental bronchus 10 is closed. As the collapse starts, the aspiration valve 11 is closed. This can be seen from curve K2. The aspiration valve 11 is opened in rhythm with the new inhalation action EV in accordance with FIGS. 5 and 6 of the endoscopy sequence. The underpressure U of 5 mbar is then applied, as indicated in curve K3, and the aspiration procedure is carried out.

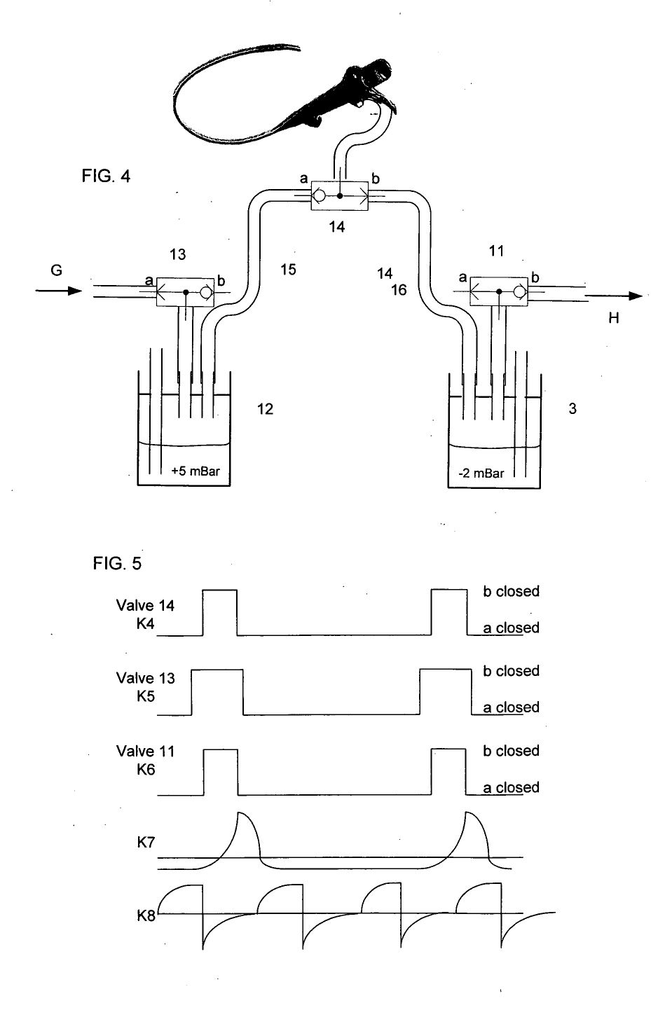

The arrangement shown in FIG. 4 also comprises a bronchoscope 1 with a bronchial catheter 2 and an aspiration device 3. The aspiration valve of the aspiration device 3 is once again designated by 11. It will be seen that a pressure generator 12 with associated valve unit 13 is integrated into the arrangement. This pressure generator 12 is used to deliver a compressed gas pulse G to the lung L or segmental bronchus 10 (cf. FIG. 1). The compressed gas pulse G is delivered in synchrony with the aspiration of the air. In this way, the associated segmental bronchus 10 is widened so that its volume remains steady during the aspiration procedure. Collapsing is prevented, and the aspiration procedure is successfully performed. The pressure generator 12 is switched on via a control valve 14 which links the aspiration device 3 and the pressure generator 12. The inward and outward lines are designated generally by 15 and 16 in FIG. 4.

In the time profile shown in FIG. 5 the aspiration vacuum is interrupted by brief positive pressure pulses as indicated by curve K7 which shows the pressure in the segmental bronchus 10. The positive pressure pulses act to puff open airways that are potentially collapsed or otherwise act to expand the airways to make the aspiration phase more effective. The timing of the positive pressure pulses can be independent of the patient's respiratory pattern K8 as described in FIG. 5, or alternatively can be synchronized as previously described. In FIGS. 4 and 5 the valves 11, 13 and 14 are normally open valves which when energized close to the positions indicated by K4, K5 and K6 to achieve the positive pressure pulse shown in K7.

In a further advantageous embodiment, the in-situ condition in the segmental bronchus is visually monitored by means of the visual imaging unit 9, and an image thereof is recorded. By evaluation of the recorded image signals, a collapse or an imminent collapse is detected and the pressure generator 12 accordingly controlled, so that a collapse can be avoided.

1. A method for aspirating a hyperextended region of a patient's lung, said method comprising:
monitoring the patient's respiration to determine periods of inspiration and exhalation; and
aspirating air from the hyperextended region during periods of inspiration but not during periods of exhalation.

2. A method as in claim 1, wherein aspirating comprises isolating the hyperextended region from other regions of the lungs, introducing a bronchial catheter into the isolated region, and applying a negative pressure to the catheter during periods of inspiration but not during periods of exhalation.

3. A method as in claim 1 or 2, wherein monitoring comprises receiving a signal from a thorax impedance sensor on the patient's chest.

4. A method as in claim 1 or 2, wherein monitoring comprises receiving a signal from an acoustic measurement sensor.

5. A method as in claim 1 or 2, wherein monitoring comprises receiving a signal from an inductance respirometer.

6. A method as in claim 2, further comprising delivering compressed gas through the bronchial catheter to the hyperextended region prior to and/or during an initial phase of aspiration.

7. A system for aspirating a hyperextended region of a patient's lung, said system comprising:
a bronchial catheter configured to access said hyperextended lung region;
a sensor configured to distinguish between periods of inspiration and exhalation during the patient's spontaneous respiration cycle; and
an aspiration device connectable to the bronchial catheter and the sensor, said aspiration device having a control unit configured to aspirate air from the hyperextended region during periods of inspiration but not during periods of exhalation.

8. A system as in claim 7, wherein the sensor measures thorax impedance on the patient's chest.

9. A system as in claim 7, wherein the sensor measures sound.

10. A system as in claim 7, wherein the sensor comprises and inductance respirometer.

11. A system as in any one of claims 7 to 10, further comprising a gas pulse generator connectable to the bronchial catheter and the sensor, said gas pulse generator having a valve unit which delivers compressed gas through the bronchial catheter to the hyperextended region prior to and/or during and initial phase of aspiration through the aspiration device.

12. A system as in claim 11, further comprising an imaging unit for imaging the hyperextended lung area during treatment.

13. A system as in claim 12, wherein the imaging unit is coupled to the valve unit of the gas pulse generator.

14. A method for aspirating a hyperextended region of a patient's lung, said method comprising:
aspirating air from the hyperextended region; and
delivering short pulses of compressed gas to the hyperextended region in order to open air passages to allow aspiration.

15. A method as in claim 14, wherein the gas is selected from the group consisting of air, heliox, helium, or nitrogen.
